(19) United States
(12) Patent Application Publication
(10) Pub. No.: US 2024/0422755 A1
(43) Pub. Date: Dec. 19, 2024

(54) TRANSMISSION METHOD AND APPARATUS, TERMINAL, AND STORAGE MEDIUM

(71) Applicant: VIVO MOBILE COMMUNICATION CO., LTD., Dongguan (CN)

(72) Inventors: Can LI, Dongguan (CN); Siqi LIU, Dongguan (CN); Gen LI, Dongguan (CN); Zichao JI, Dongguan (CN)

(73) Assignee: VIVO MOBILE COMMUNICATION CO., LTD., Dongguan (CN)

(21) Appl. No.: 18/820,234

(22) Filed: Aug. 29, 2024

Related U.S. Application Data
(63) Continuation of application No. PCT/CN2023/077648, filed on Feb. 22, 2023.

(30) Foreign Application Priority Data
Mar. 1, 2022 (CN) 202210195795.0

(51) Int. Cl. H04W 72/0453

(52) U.S. Cl. CPC H04W 72/0453

(57) ABSTRACT

A transmission method, a terminal, and a non-transitory computer-readable storage medium are provided. The transmission method includes: when a configured resource for a terminal includes N frequency domain resources, and a preset condition is satisfied by the terminal, performing transmission on a frequency domain resource in the N frequency domain resources. The transmission is performed based on a transmitter which is any of M transmitters, and N is an integer greater than 2. The terminal has M transmitters, or the terminal performs transmission on a maximum of M transmitters simultaneously. M is a positive integer less than or equal to N.

### CROSS-REFERENCE TO RELATED APPLICATIONS

This application is a continuation of International Application No. PCT/CN2023/077648, filed on Feb. 22, 2023, which claims priority to Chinese Patent Application No. 202210195795.0, filed on Mar. 1, 2022. The entire contents of each of the above-referenced applications are expressly incorporated herein by reference.

### TECHNICAL FIELD

This application pertains to the field of communication technologies, and specifically relates to a transmission method and apparatus, a terminal, and a storage medium.

### BACKGROUND

In some communication systems (for example, 5th Generation (5G) Mobile Communication Technology or 6th Generation (6G) Mobile Communication Technology systems), a terminal supports transmission on a maximum of two frequency domain resources. For example, the terminal can perform 1-port transmission on two bands simultaneously or perform 2-port transmission on one band. Because the terminal supports transmission on a maximum of two frequency domain resources, transmission performance of the terminal is poor.

### SUMMARY

Embodiments of this application provide a transmission method and apparatus, a terminal, and a storage medium.

According to a first aspect, a transmission method is provided, including: in a case that a configured resource for a terminal includes N frequency domain resources, and a preset condition is satisfied by the terminal, performing transmission on a frequency domain resource in the N frequency domain resources, where the transmission is performed based on a transmitter which is any of M transmitters, and N is an integer greater than 2.

The terminal has M transmitters, or the terminal is capable of performing transmission on a maximum of M transmitters simultaneously, where M is a positive integer less than or equal to N.

According to a second aspect, a transmission apparatus is provided, including: a transmission module, configured to: in a case that a configured resource for a terminal includes N frequency domain resources, and a preset condition is satisfied by the terminal, perform transmission on a frequency domain resource in the N frequency domain resources, where the transmission is performed based on a transmitter which is any of M transmitters, and N is an integer greater than 2.

The terminal has M transmitters, or the terminal is capable of performing transmission on a maximum of M transmitters simultaneously, where M is a positive integer less than or equal to N.

According to a third aspect, a terminal is provided, including a processor and a memory. The memory stores a program or an instruction executable on the processor, and when the program or the instruction is executed by the processor, steps of the transmission method provided in embodiments of this application are implemented.

According to a fourth aspect, a terminal is provided, including a processor and a communication interface. The communication interface is configured to: in a case that a configured resource for a terminal includes N frequency domain resources, and a preset condition is satisfied by the terminal, perform transmission on a frequency domain resource in the N frequency domain resources, where the transmission is performed based on a transmitter which is any of M transmitters, and N is an integer greater than 2.

The terminal has M transmitters, or the terminal is capable of performing transmission on a maximum of M transmitters simultaneously, where M is a positive integer less than or equal to N.

According to a fifth aspect, a readable storage medium is provided. The readable storage medium stores a program or an instruction, and when the program or the instruction is executed by a processor, steps of the transmission method provided in embodiments of this application are implemented.

According to a sixth aspect, a computer program product is provided. The computer program product is stored in a storage medium, and when the computer program product is executed by at least one processor, steps of the transmission method provided in embodiments of this application are implemented.

According to a seventh aspect, a chip is provided. The chip includes a processor and a communication interface, the communication interface is coupled to the processor, and the processor is configured to run a program or an instruction, to implement steps of the transmission method provided in embodiments of this application.

According to an eighth aspect, a terminal is provided. The terminal is configured to implement steps of the transmission method provided in embodiments of this application.

In embodiments of this application, in a case that a configured resource for a terminal includes N frequency domain resources, and a preset condition is satisfied by the terminal, transmission is performed on a frequency domain resource in the N frequency domain resources, where the transmission is performed based on a transmitter which is any of M transmitters, and N is an integer greater than 2. The terminal has M transmitters, or the terminal is capable of performing transmission on a maximum of M transmitters simultaneously, where M is a positive integer less than or equal to N. In this way, transmission can be performed on at least two frequency domain resources, to improve transmission performance of the terminal.

### BRIEF DESCRIPTION OF DRAWINGS

FIG. 1 is a block diagram of a wireless communication system to which embodiments of this application are applicable;

FIG. 2 is a flowchart of a transmission method according to an embodiment of this application;

FIG. 3 is a diagram of a structure of a transmission apparatus according to an embodiment of this application;

FIG. 4 is a diagram of a structure of a communication device according to an embodiment of this application; and

FIG. 5 is a diagram of a structure of a terminal according to an embodiment of this application.

### DETAILED DESCRIPTION

The following clearly describes technical solutions in embodiments of this application with reference to accompanying drawings in embodiments of this application. Apparently, the described embodiments are some but not all of embodiments of this application. All other embodiments obtained by a person of ordinary skill in the art based on embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that embodiments of this application can be implemented in an order other than the order illustrated or described herein. Objects classified by “first” and “second” are usually of a same type, and a quantity of objects is not limited. For example, there may be one or more first objects. In addition, in this specification and the claims, “and/or” indicates at least one of connected objects, and the character “/” generally indicates an “or” relationship between associated objects.

It should be noted that technologies described in embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA), and other systems. The terms “system” and “network” in embodiments of this application may be used interchangeably. The described technologies can be applied to the systems and the radio technologies mentioned above, and can be applied to other systems and radio technologies. A New Radio (NR) system is described below for illustrative purposes, and NR terminology is used in most of the following descriptions, but these technologies can be further applied to applications other than NR system applications, for example, a 6G communication system.

FIG. 1 is a block diagram of a wireless communication system to which embodiments of this application are applicable. The wireless communication system includes terminals 11 and a network side device 12. The terminal 11 may be a terminal side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home (a home device having a wireless communication function, such as a refrigerator, a television, a washing machine, or furniture), a game console, a Personal Computer (PC), a teller machine, or a self-service machine. The wearable device includes a smart watch, a smart band, a smart headset, smart glasses, smart jewelry (a smart bracelet, a smart chain bracelet, a smart ring, a smart necklace, a smart anklet, or a smart chain anklet), a smart wrist strap, smart clothing, and the like. It should be noted that a specific type of the terminal 11 is not limited in embodiments of this application. The network side device 12 may include an access network device or a core network device. The access network device 12 may also be referred to as a radio access network device, a Radio Access Network (RAN), a radio access network function, or a radio access network unit. The access network device 12 may include a base station, a Wireless Local Area Network (WLAN) access point, a Wi-Fi node, and the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmission and Reception Point (TRP), or another appropriate term in the art. As long as a same technical effect is achieved, the base station is not limited to a specified technical term. It should be noted that, in embodiments of this application, a base station in an NR system is merely used as an example for description, and a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), Unified Data Management (UDM), a Unified Data Repository (UDR), a Home Subscriber Server (HSS), a Centralized Network Configuration (CNC), a Network Repository Function (NRF), a Network Exposure Function (NEF), a Local NEF (L-NEF), a Binding Support Function (BSF), an Application Function (AF), and the like. It should be noted that, in embodiments of this application, a core network device in an NR system is merely used as an example for description, and a specific type of the core network device is not limited.

A transmission method and apparatus, a terminal, and a storage medium provided in embodiments of this application are described below in detail with reference to the accompanying drawings by using some embodiments and application scenarios thereof.

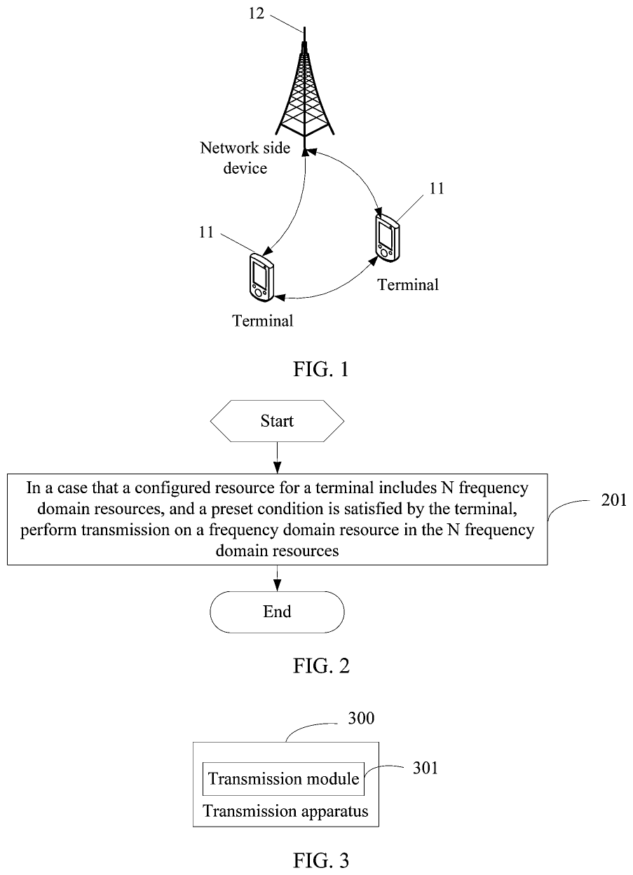

FIG. 2 is a flowchart of a transmission method according to an embodiment of this application. As shown in FIG. 2, the method includes the following steps:

Step 201: In a case that a configured resource for a terminal includes N frequency domain resources, and a preset condition is satisfied by the terminal, perform transmission on a frequency domain resource in the N frequency domain resources, where the transmission is performed based on a transmitter which is any of M transmitters, and N is an integer greater than 2.

The terminal has M transmitters, or the terminal is capable of performing transmission on a maximum of M transmitters simultaneously, where M is a positive integer less than or equal to N.

In this embodiment of this application, the frequency domain resource includes one of the following:
a band, a carrier, a Bandwidth Part (BWP), or a resource pool.

The N frequency domain resources may be three or more bands, carriers, BWPs, or resource pools.

The configured resource for the terminal may be a resource configured by a network side device for the terminal.

That a preset condition is satisfied may be that a condition configured by the network side device or a condition agreed upon in a protocol is satisfied, and may be that at least one of transmission, a configuration, a capability, and the like of the terminal satisfies the preset condition.

The M transmitters may be Uplink Transmitters (UL Txs), or may be Signaling Link Transmitters (SL Txs). In some implementations, M may be equal to 2; in some alternative implementations, M is equal to N, for example, N is 3, and M is also 3.

Performing transmission on a frequency domain resource in the N frequency domain resources may be performing transmission on a part or all of the N frequency domain resources, and the transmission is performed by using all or a part of the M transmitters. For example, quantities of Txs of the terminal on N bands, carriers, BWPs, or resource pools are T1, T2, . . . , and TN respectively, where sum(T1, T2, . . . , TN)=M, 0≤Tm≤M, and 0≤m≤N.

In this embodiment of this application, the foregoing step can be used to implement transmission on at least two frequency domain resources, to improve transmission performance of the terminal.

In an implementation, performing transmission on a frequency domain resource in the N frequency domain resources includes:
performing Tx switching on a frequency domain resource in the N frequency domain resources, and performing transmission based on a switched-to frequency domain resource.

The Tx switching may include at least one of the following:
a frequency domain resource index for transmission changes;
a quantity of transmitters, antenna ports, layers, or resource pools changes; and a quantity of frequency domain resources for transmission changes.

For example, the performing Tx switching on a frequency domain resource in the N frequency domain resources may be: changing a frequency domain resource index of a part or all of the N frequency domain resources for transmission, changing a quantity of transmitters, antenna ports, layers, or resource pools on a part or all of the N frequency domain resources for transmission, or changing a quantity of frequency domain resources in the N frequency domain resources for transmission.

In this implementation, Tx switching can be performed on a frequency domain resource in the N frequency domain resources, and transmission is performed based on a switched-to transmitter, to further improve the transmission performance of the terminal. For example, on some resources, using one transmitter may be changed to using two transmitters for transmission, or on some resources, using one antenna port may be changed to using two antenna ports for transmission.

In an implementation, the quantity of antenna ports for transmission of the terminal on a first frequency domain resource is less than or equal to a quantity of transmitters of the terminal on the first frequency domain resource, and the first frequency domain resource is any one of the N frequency domain resources.

That the first frequency domain resource is any one of the N frequency domain resources may be understood as follows: the quantity of antenna ports for transmission of the terminal on each frequency domain resource is less than or equal to a quantity of transmitters on the frequency domain resource. For example, the quantity of antenna ports on each band, carrier, BWP, or resource pool is less than or equal to the quantity of Txs on the band, carrier, BWP, or resource pool.

In this implementation, each combination (or referred to as a mapping relationship) of Txs and/or ports may include a quantity or indexes of Txs on each frequency domain resource, and include a quantity or indexes of antenna ports on each frequency domain resource. In each combination, a quantity of antennas on each frequency domain resource is less than or equal to a quantity of Txs on the frequency domain resource.

In this implementation, the quantity of antenna ports for transmission on the first frequency domain resource is less than or equal to the quantity of transmitters of the terminal on the first frequency domain resource, so that each antenna port can correspond to at least one transmitter, to improve transmission reliability of the terminal.

In an implementation, that a preset condition is satisfied includes at least one of the following:
the terminal has a Tx switching capability on at least a part of the N frequency domain resources;
the terminal receives triggering signaling used to trigger Tx switching; preceding transmission performed by the terminal satisfies a first preset requirement; transmission that is currently performed by the terminal satisfies the first preset requirement;
transmission that is to be performed by the terminal satisfies a second preset requirement; and the terminal satisfies a third preset requirement.

That the terminal has a Tx switching capability on at least a part of the N frequency domain resources may be that the terminal has a Tx switching capability on each of the N frequency domain resources, or has a Tx switching capability on a part of the frequency domain resources.

That the terminal receives triggering signaling used to trigger Tx switching may be that the terminal receives triggering signaling sent by the network side device or another Signaling Link (SL) terminal.

The preceding transmission performed by the terminal may be transmission completed before the terminal performs Tx switching.

That the terminal satisfies a third preset requirement may be that behavior, a status, or the like of the terminal satisfies the third preset requirement.

The first preset requirement, the second preset requirement, and the third preset requirement may be configured by the network side device or agreed upon in a protocol.

In an implementation, the first preset requirement includes: the terminal performs 1-port transmission in a first frequency domain resource set; and/or
the second preset requirement includes: the terminal performs 1-port transmission in a second frequency domain resource set; and/or
the third preset requirement includes at least one of the following:
the terminal does not support or perform or is not configured or scheduled with 2-port transmission on each frequency domain resource in the first frequency domain resource set and the second frequency domain resource set; and
the terminal supports or performs or is configured or scheduled with only 1-port transmission on each frequency domain resource in the first frequency domain resource set and the second frequency domain resource set.

The first frequency domain resource set may include one or more frequency domain resources, and the second frequency domain resource set may include one or more frequency domain resources.

The first frequency domain resource set and the second frequency domain resource set may separately include different frequency domain resources in the N frequency domain resources.

In some alternative embodiments, the first frequency domain resource set includes a first part of frequency domain resource in the N frequency domain resources, the second frequency domain resource set includes a second part of frequency domain resource in the N frequency domain resources, and the first part of frequency domain resource and the second part of frequency domain resource are partially overlapped.

For example, the first frequency domain resource set and the second frequency domain resource set include different P frequency domain resources and Q frequency domain resources respectively, there is no intersection between the P frequency domain resources and the Q frequency domain resources, and a union of the first frequency domain resource set and the second frequency domain resource set may be or may not be equal to the N frequency domain resources.

In some alternative embodiments, the first frequency domain resource set and the second frequency domain resource set include P frequency domain resources and Q frequency domain resources respectively, and the P frequency domain resources and the Q frequency domain resources may be partially overlapped.

In this implementation, there are two manners for the terminal to perform transmission:
the terminal cannot perform transmission on different carriers simultaneously; or
the terminal can perform transmission on different carriers simultaneously.

The foregoing two types may be indicated by a network parameter.

In this implementation, in a case that preceding transmission performed by the terminal or transmission that is currently performed or to be performed by the terminal is 1-port transmission, or in a case that the terminal does not support or perform or is not configured or scheduled with 2-port transmission or supports or performs or is configured or scheduled with only 1-port transmission on each frequency domain resource in the first frequency domain resource set and the second frequency domain resource set, the terminal performs transmission on the N frequency domain resources, and may perform Tx switching on the N frequency domain resources, to improve the transmission performance of the terminal.

In another implementation, the first preset requirement includes: the terminal performs 1-port transmission in a first frequency domain resource set; and/or
the second preset requirement includes: the terminal performs 1-port or 2-port transmission in a second frequency domain resource set; and/or
the third preset requirement includes at least one of the following:
the terminal supports or performs or is configured or scheduled with 2-port transmission on at least one frequency domain resource in the second frequency domain resource set; and
the terminal does not support or perform or is not configured or scheduled with 2-port transmission on a frequency domain resource in the first frequency domain resource set.

In this implementation, for the first frequency domain resource set and the second frequency domain resource set, reference may be made to the descriptions of the foregoing implementation. In addition, in this implementation, there may also be two manners for the terminal to perform transmission:
the terminal cannot perform transmission on different carriers simultaneously; or
the terminal can perform transmission on different carriers simultaneously.

In this implementation, in a case that preceding transmission performed by the terminal or transmission that is currently performed by the terminal is 1-port transmission, or in a case that transmission that is to be performed by the terminal is 1-port or 2-port transmission, or in a case that the terminal supports or performs or is configured or scheduled with 2-port transmission on at least one frequency domain resource in the second frequency domain resource set or does not support or perform or is not configured or scheduled with 2-port transmission on a frequency domain resource in the first frequency domain resource set, the terminal performs transmission on the N frequency domain resources, and may perform Tx switching on the N frequency domain resources, to improve the transmission performance of the terminal.

In another implementation, the first preset requirement includes: the terminal performs 1-port or 2-port transmission in a first frequency domain resource set; and/or
the second preset requirement includes: the terminal performs 1-port transmission in a second frequency domain resource set; and/or
the third preset requirement includes at least one of the following:
the terminal supports or performs or is configured or scheduled with 2-port transmission on at least one frequency domain resource in the first frequency domain resource set; and
the terminal does not support or perform or is not configured or scheduled with 2-port transmission on a frequency domain resource in the second frequency domain resource set.

In this implementation, for the first frequency domain resource set and the second frequency domain resource set, reference may be made to the descriptions of the foregoing implementation. In addition, in this implementation, there may also be two manners for the terminal to perform transmission:
the terminal cannot perform transmission on different carriers simultaneously; or
the terminal can perform transmission on different carriers simultaneously.

In this implementation, in a case that preceding transmission performed by the terminal or transmission that is currently performed by the terminal is 1-port or 2-port transmission, or in a case that transmission that is to be performed by the terminal is 1-port transmission, or in a case that the terminal supports or performs or is configured or scheduled with 2-port transmission on at least one frequency domain resource in the first frequency domain resource set or the terminal does not support or perform or is not configured or scheduled with 2-port transmission on a frequency domain resource in the second frequency domain resource set, the terminal performs transmission on the N frequency domain resources, and may perform Tx switching on the N frequency domain resources, to improve the transmission performance of the terminal.

In another implementation, the first preset requirement includes: the terminal performs 2-port transmission in a first frequency domain resource set; and/or
the second preset requirement includes: the terminal performs 2-port transmission in a second frequency domain resource set; and/or
the third preset requirement includes at least one of the following:
the terminal supports or performs or is configured or scheduled with 2-port transmission on at least one frequency domain resource in the first frequency domain resource set; the terminal supports or performs or is configured or scheduled with 2-port transmission on at least one frequency domain resource in the second frequency domain resource set; and
the terminal supports or performs or is configured or scheduled with 2-port transmission on a current frequency domain resource.

In this implementation, for the first frequency domain resource set and the second frequency domain resource set, reference may be made to the descriptions of the foregoing implementation. In addition, in this implementation, there may also be two manners for the terminal to perform transmission:
the terminal cannot perform transmission on different carriers simultaneously; or
the terminal can perform transmission on different carriers simultaneously.

In this implementation, in a case that preceding transmission performed by the terminal or transmission that is currently performed by the terminal is 2-port transmission, or in a case that transmission that is to be performed by the terminal is 2-port transmission, or in a case that the terminal supports or performs or is configured or scheduled with 2-port transmission on at least one frequency domain resource in the first frequency domain resource set or the terminal supports or performs or is configured or scheduled with 2-port transmission on at least one frequency domain resource in the second frequency domain resource set, the terminal performs transmission on the N frequency domain resources, and may perform Tx switching on the N frequency domain resources, to improve the transmission performance of the terminal.

In an implementation, the terminal supports at least one of the following antenna transmitting modes:
a first mode, where the first mode indicates that transmitting on only one transmitter is allowed to be performed on one frequency domain resource, or the first mode indicates that transmitting through only one antenna port is allowed to be performed on one frequency domain resource;
a second mode, where the second mode indicates that transmitting on two transmitters is supported on at least one frequency domain resource, and transmitting on only one transmitter is supported on at least one frequency domain resource, or the second mode indicates that transmitting through two antenna ports is supported on at least one frequency domain resource, and transmitting through only one antenna port is supported on at least one frequency domain resource; and
a third mode, where the third mode indicates that transmitting on two transmitters is supported on at least two frequency domain resources, or the third mode indicates that transmitting through two antenna ports is supported on at least two frequency domain resources.

That transmitting through only one antenna port is supported on at least one frequency domain resource may be that transmitting through a maximum of one antenna port is supported on at least one frequency domain resource.

For example, the first mode, the second mode, and the third mode may be respectively represented as follows:
1Tx-1Tx, indicating that only 1-Tx or 1-port transmission can be transmitted on one band, carrier, BWP, or resource pool;
1Tx-2Tx, indicating that 2-Tx or 2-port transmission can be transmitted on at least one band, carrier, BWP, or resource pool, and only 1-Tx or 1-port transmission can be transmitted on at least one band, carrier, BWP, or resource pool; and
2Tx-2Tx, indicating that 2-Tx or 2-port transmission can be transmitted on at least two bands, carriers, BWPs, or resource pools.

In this implementation, flexible transmission can be implemented in a plurality of antenna modes.

In an implementation, an antenna transmitting mode supported by the terminal is related to at least one of the following:
a capability of the terminal and a network configuration; and/or
at least one of the first preset requirement, the second preset requirement, and the third preset requirement is associated with the antenna transmitting mode supported by the terminal.

In this implementation, the antenna transmitting mode supported by the terminal can be determined based on at least one of the capability of the terminal and the network configuration. For example, the first mode, the second mode, or the third mode may be determined based on at least one of the capability of the terminal and the network configuration, so that the antenna transmitting mode of the terminal matches the capability of the terminal and the network configuration.

In addition, the first preset requirement, the second preset requirement, or the third preset requirement may be determined according to the antenna transmitting mode, so that a condition for triggering transmission and Tx switching by the terminal matches the antenna transmitting mode supported by the terminal. In this way, the terminal can better perform transmission and Tx switching.

In an implementation, after switching, in a case that same antenna ports correspond to different transmitter combinations, the terminal determines, based on first indication information transmitted by a network side, target transmitter combinations corresponding to the same antenna ports.

The first indication information may be a higher-layer parameter configuration, a Downlink Control Information (DCI) indication, or a DCI format.

Determining target transmitter combinations corresponding to the same antenna ports means distinguishing between transmitter combinations corresponding to antenna ports that are determined to be the same, so as to determine a target transmit combination corresponding to each antenna port.

In this implementation, after switching, in a case that same antenna ports correspond to different transmitter combinations, the first indication information is used, to distinguish between the corresponding transmitter combinations, so as to ensure transmission performed through each antenna port is performed by using a corresponding transmitter, and improve transmission reliability.

In this embodiment of this application, in a case that a configured resource for a terminal includes N frequency domain resources, and a preset condition is satisfied by the terminal, transmission is performed on the N frequency domain resources, where N is an integer greater than 2. The terminal has M transmitters, or the terminal is capable of performing transmission on a maximum of M transmitters simultaneously, where M is a positive integer less than or equal to N. In this way, transmission can be performed on at least two frequency domain resources, to improve transmission performance of the terminal.

An example in which the frequency domain resource is a band is used below to describe the Tx switching in this embodiment of this application.

In the following embodiments, manners may be divided into Manner 1 and Manner 2 according to whether performing uplink transmission on a plurality of frequency domains simultaneously is supported. Manner 1 indicates that uplink transmission cannot be performed on a plurality of carriers simultaneously, and Manner 2 indicates that uplink transmission can be performed on a plurality of carriers simultaneously. In addition, N indicates that N bands are configured for the terminal, and M indicates that the terminal has M transmitters, or the terminal can perform transmission on a maximum of M transmitters simultaneously.

### Embodiment 1-0

In this implementation, when N=3, M=2, and three carriers are on the three bands respectively, a first preset requirement, a second preset requirement, and a third preset requirement in this embodiment of this application may include at least one of the following combinations of Txs and/or antenna ports shown in Table 1. Manner 1 and Manner 2 are configured or indicated by using a network. Quantities of Txs and quantities of ports on carrier (layer) 1, carrier 2, and carrier 3 may be shown in Table 1.

TABLE 1

| | | Quantities of antenna ports for uplink |
|---|---|---|
| | Quantities of | transmission (band A (carrier 1) + band B |
| | transmitters | (carrier 2) + band C (carrier 3)) |
| Case 1 | 1T + 1T + 0T | 1P + 0P + 0P, 0P + 1P + 0P |
| Case 2 | 0T + 2T + 0T | 0P + 2P + 0P, 0P + 1P + 0P |
| Case 3 | 2T + 0T + 0T | 2P + 0P + 0P, 1P + 0P + 0P |
| Case 4 | 0T + 0T + 2T | 0P + 0P + 2P, 0P + 0P + 1P |
| Case 5 | 1T + 0T + 1T | 1P + 0P + 0P, 0P + 0P + 1P |
| Case 6 | 0T + 1T + 1T | 0P + 1P + 0P, 0P + 0P + 1P |

All possible included switching solutions may be shown in the following plurality of tables.

A first switching solution shown in Table 2 is switching from Case 1 to Case 2, for example, switching from 1P+0P+0P to 0P+2P+0P or 0P+P+0P, or may be switching from Case 2 to Case 1. In other words, different cases in the tables provided in this embodiment of this application may be switched to each other.

TABLE 2

| | | Quantities of antenna ports for uplink |
|---|---|---|
| | Quantities of | transmission (band A (carrier 1) + band B |
| | transmitters | (carrier 2) + band C (carrier 3)) |
| Case 1 | 1T + 1T + 0T | 1P + 0P + 0P, 0P + 1P + 0P |
| Case 2 | 0T + 2T + 0T | 0P + 2P + 0P, 0P + 1P + 0P |

TABLE 3

| | | Quantities of antenna ports for uplink |
|---|---|---|
| | Quantities of | transmission (band A (carrier 1) + band B |
| | transmitters | (carrier 2) + band C (carrier 3)) |
| Case 1 | 1T + 1T + 0T | 1P + 0P + 0P, 0P + 1P + 0P |
| Case 3 | 2T + 0T + 0T | 2P + 0P + 0P, 1P + 0P + 0P |

TABLE 4

| | | Quantities of antenna ports for uplink |
|---|---|---|
| | Quantities of | transmission (band A (carrier 1) + band B |
| | transmitters | (carrier 2) + band C (carrier 3)) |
| Case 2 | 0T + 2T + 0T | 0P + 2P + 0P, 0P + 1P + 0P |
| Case 6 | 0T + 1T + 1T | 0P + 1P + 0P, 0P + 0P + 1P |

TABLE 5

| | | Quantities of antenna ports for uplink |
|---|---|---|
| | Quantities of | transmission (band A (carrier 1) + band B |
| | transmitters | (carrier 2) + band C (carrier 3)) |
| Case 3 | 2T + 0T + 0T | 2P + 0P + 0P, 1P + 0P + 0P |
| Case 5 | 1T + 0T + 1T | 1P + 0P + 0P, 0P + 0P + 1P |

TABLE 6

| | | Quantities of antenna ports for uplink |
|---|---|---|
| | Quantities of | transmission (band A (carrier 1) + band B |
| | transmitters | (carrier 2) + band C (carrier 3)) |
| Case 4 | 0T + 0T + 2T | 0P + 0P + 2P, 0P + 0P + 1P |
| Case 5 | 1T + 0T + 1T | 1P + 0P + 0P, 0P + 0P + 1P |

TABLE 7

| | | Quantities of antenna ports for uplink |
|---|---|---|
| | Quantities of | transmission (band A (carrier 1) + band B |
| | transmitters | (carrier 2) + band C (carrier 3)) |
| Case 4 | 0T + 0T + 2T | 0P + 0P + 2P, 0P + 0P + 1P |
| Case 6 | 0T + 1T + 1T | 0P + 1P + 0P, 0P + 0P + 1P |

TABLE 8

| | | Quantities of antenna ports for uplink |
|---|---|---|
| | Quantities of | transmission (band A (carrier 1) + band B |
| | transmitters | (carrier 2) + band C (carrier 3)) |
| Case 2 | 0T + 2T + 0T | 0P + 2P + 0P, 0P + 1P + 0P |
| Case 3 | 2T + 0T + 0T | 2P + 0P + 0P, 1P + 0P + 0P |

TABLE 9

| | | Quantities of antenna ports for uplink |
|---|---|---|
| | Quantities of | transmission (band A (carrier 1) + band B |
| | transmitters | (carrier 2) + band C (carrier 3)) |
| Case 2 | 0T + 2T + 0T | 0P + 2P + 0P, 0P + 1P + 0P |
| Case 4 | 0T + 0T + 2T | 0P + 0P + 2P, 0P + 0P + 1P |

TABLE 10

| | | Quantities of antenna ports for uplink |
|---|---|---|
| | Quantities of | transmission (band A (carrier 1) + band B |
| | transmitters | (carrier 2) + band C (carrier 3)) |
| Case 3 | 2T + 0T + 0T | 2P + 0P + 0P, 1P + 0P + 0P |
| Case 4 | 0T + 0T + 2T | 0P + 0P + 2P, 0P + 0P + 1P |

In switching cases in Table 2 to Table 10, Tx switching is performed on only two bands, that is, there are two bands for transmission before and after the switching.

TABLE 11

| | | Quantities of antenna ports for uplink |
|---|---|---|
| | Quantities of | transmission (band A (carrier 1) + band B |
| | transmitters | (carrier 2) + band C (carrier 3)) |
| Case 1 | 1T + 1T + 0T | 1P + 0P + 0P, 0P + 1P + 0P |
| Case 5 | 1T + 0T + 1T | 1P + 0P + 0P, 0P + 0P + 1P |

TABLE 12

| | | Quantities of antenna ports for uplink |
|---|---|---|
| | Quantities of | transmission (band A (carrier 1) + band B |
| | transmitters | (carrier 2) + band C (carrier 3)) |
| Case 1 | 1T + 1T + 0T | 1P + 0P + 0P, 0P + 1P + 0P |
| Case 6 | 0T + 1T + 1T | 0P + 1P + 0P, 0P + 0P + 1P |

TABLE 13

| | | Quantities of antenna ports for uplink |
|---|---|---|
| | Quantities of | transmission (band A (carrier 1) + band B |
| | transmitters | (carrier 2) + band C (carrier 3)) |
| Case 5 | 1T + 0T + 1T | 1P + 0P + 0P, 0P + 0P + 1P |
| Case 6 | 0T + 1T + 1T | 0P + 1P + 0P, 0P + 0P + 1P |

TABLE 14

| | | Quantities of antenna ports for uplink |
|---|---|---|
| | Quantities of | transmission (band A (carrier 1) + band B |
| | transmitters | (carrier 2) + band C (carrier 3)) |
| Case 1 | 1T + 1T + 0T | 1P + 0P + 0P, 0P + 1P + 0P |
| Case 4 | 0T + 0T + 2T | 0P + 0P + 2P, 0P + 0P + 1P |

TABLE 15

| | | Quantities of antenna ports for uplink |
|---|---|---|
| | Quantities of | transmission (band A (carrier 1) + band B |
| | transmitters | (carrier 2) + band C (carrier 3)) |
| Case 2 | 0T + 2T + 0T | 0P + 2P + 0P, 0P + 1P + 0P |
| Case 5 | 1T + 0T + 1T | 1P + 0P + 0P, 0P + 0P + 1P |

TABLE 16

| | | Quantities of antenna ports for uplink |
|---|---|---|
| | Quantities of | transmission (band A (carrier 1) + band B |
| | transmitters | (carrier 2) + band C (carrier 3)) |
| Case 3 | 2T + 0T + 0T | 2P + 0P + 0P, 1P + 0P + 0P |
| Case 6 | 0T + 1T + 1T | 0P + 1P + 0P, 0P + 0P + 1P |

In switching in Table 11 to Table 16, Tx switching is performed on three bands, that is, there are three bands for transmission before and after the switching.

When Manner 1 is configured, only 1-port transmission can be supported, performed, configured, or scheduled on each band, and 1Tx-1Tx switching is performed on any two bands, the terminal cannot perform transmission on the switched two/any carriers within switching time.

Each transmitter combination corresponds to one antenna port combination. In this case, user equipment (User Equipment, UE) performs 1-port transmission on one band before switching, and performs 1-port transmission on another band after switching. Details may be shown in Table 17.

TABLE 17

| | | Quantities of antenna ports for uplink |
|---|---|---|
| | Quantities of | transmission (band A (carrier 1) + band B |
| | transmitters | (carrier 2) + band C (carrier 3)) |
| Case 1 | 1T + 1T + 0T | 1P + 0P + 0P |
| Case 5 | 1T + 0T + 1T | 0P + 0P + 1P |
| Case 6 | 0T + 1T + 1T | 0P + 1P + 0P |

In some alternative embodiments, each transmitter combination corresponds to a plurality of antenna port combinations. In this case, UE performs 1-port transmission on one band before switching, and performs 1-port transmission on another band after switching. Details may be shown in Table 18.

TABLE 18

| | | Quantities of antenna ports for uplink |
|---|---|---|
| | Quantities of | transmission (band A (carrier 1) + band B |
| | transmitters | (carrier 2) + band C (carrier 3)) |
| Case 1 | 1T + 1T + 0T | 1P + 0P + 0P, 0P + 1P + 0P |
| Case 5 | 1T + 0T + 1T | 1P + 0P + 0P, 0P + 0P + 1P |
| Case 6 | 0T + 1T + 1T | 0P + 1P + 0P, 0P + 0P + 1P |

### Embodiment 1-2

Manner 1 is configured, there is one Tx on each of two bands, and both Txs are switched to a third band.

UE performs 1-port transmission on one band before switching, and performs 1-port transmission on another band after switching.

In some alternative embodiments, UE performs 1-port transmission on one band before switching, and performs 2-port transmission on another band after switching.

### Embodiment 1-3

Manner 1 is configured, and two Txs on one band are switched to other two bands respectively.

UE performs 1-port transmission on one band before switching, and performs 1-port transmission on another band after switching.

In some alternative embodiments, UE performs 2-port transmission on one band before switching, and performs 1-port transmission on another band after switching. Details may be shown in Table 19, Table 20, or Table 21.

TABLE 19

| | | Quantities of antenna ports for uplink |
|---|---|---|
| | Quantities of | transmission (band A (carrier 1) + band B |
| | transmitters | (carrier 2) + band C (carrier 3)) |
| Case 1 | 1T + 1T + 0T | 1P + 0P + 0P, 0P + 1P + 0P |
| Case 4 | 0T + 0T + 2T | 0P + 0P + 2P, 0P + 0P + 1P |

TABLE 20

| | | Quantities of antenna ports for uplink |
|---|---|---|
| | Quantities of | transmission (band A (carrier 1) + band B |
| | transmitters | (carrier 2) + band C (carrier 3)) |
| Case 2 | 0T + 2T + 0T | 0P + 2P + 0P, 0P + 1P + 0P |
| Case 5 | 1T + 0T + 1T | 1P + 0P + 0P, 0P + 0P + 1P |

TABLE 21

| | | Quantities of antenna ports for uplink |
|---|---|---|
| | Quantities of | transmission (band A (carrier 1) + band B |
| | transmitters | (carrier 2) + band C (carrier 3)) |
| Case 3 | 2T + 0T + 0T | 2P + 0P + 0P, 1P + 0P + 0P |
| Case 6 | 0T + 1T + 1T | 0P + 1P + 0P, 0P + 0P + 1P |

When Manner 2 is configured, and data can be transmitted on different bands/carriers simultaneously, a combination shown in Table 22 may exist.

TABLE 22

| | | Quantities of antenna ports for uplink |
|---|---|---|
| | Quantities of | transmission (band A (carrier 1) + band B |
| | transmitters | (carrier 2) + band C (carrier 3)) |
| Case 1 | 1T + 1T + 0T | 1P + 0P + 0P, 0P + 1P + 0P, 1P + 1P + 0P |
| Case 2 | 0T + 2T + 0T | 0P + 2P + 0P, 0P + 1P + 0P |
| Case 3 | 2T + 0T + 0T | 2P + 0P + 0P, 1P + 0P + 0P |
| Case 4 | 0T + 0T + 2T | 0P + 0P + 2P, 0P + 0P + 1P |
| Case 5 | 1T + 0T + 1T | 1P + 0P + 0P, 0P + 0P + 1P, 1P + 0P + 1P |
| Case 6 | 0T + 1T + 1T | 0P + 1P + 0P, 0P + 0P + 1P, 0P + 1P + 1P |

### Embodiment 1-4

Manner 2 is configured, and only 1-port transmission can be supported on each band. When 1Tx-1Tx switching is performed on any two bands, UE cannot perform transmission on the switched two/any carriers within switching time.

UE performs 1-port transmission on one band before switching, and performs 1-port transmission on another band after switching.

In some alternative embodiments, UE performs 1-port transmission on one band before switching, and performs 1-port transmission on other two bands after switching.

In some alternative embodiments, UE performs 1-port transmission on two bands before switching, and performs 1-port transmission on another band after switching. For example, a combination shown in Table 23 may exist.

TABLE 23

| | | |
|---|---|---|
| Case 1 | 1T + 1T + 0T | 1P + 0P + 0P, 0P + 1P + 0P, 1P + 1P + 0P |
| Case 5 | 1T + 0T + 1T | 1P + 0P + 0P, 0P + 0P + 1P, 1P + 0P + 1P |
| Case 6 | 0T + 1T + 1T | 0P + 1P + 0P, 0P + 0P + 1P, 0P + 1P + 1P |

### Embodiment 1-5

Manner 2 is configured, there is one Tx on each of two bands, and both Txs are switched to a third band.

UE performs 1-port transmission on one band before switching, and performs 1-port transmission on another band after switching.

In some alternative embodiments, UE performs 1-port transmission on one band before switching, and performs 2-port transmission on another band after switching.

### Embodiment 1-6

Manner 2 is configured, and two Txs on one band are switched to other two bands respectively.

UE performs 1-port transmission on one band before switching, and performs 1-port transmission on another band after switching.

In some alternative embodiments, UE performs 2-port transmission on one band before switching, and performs 1-port transmission on another band after switching.

### Embodiment 2-0

When N=4, M=2, and there is one carrier on each band, a mapping relationship between a transmitter and an antenna port is in Manner 1.

A case that data cannot be transmitted on different bands/carriers simultaneously may be shown in Table 24.

TABLE 24

| | | Quantities of antenna ports for uplink |
|---|---|---|
| | | transmission (band A (carrier 1) + |
| | Quantities of | band B (carrier 2) + band C (carrier 3) + |
| | transmitters | band D (carrier 4)) |
| Case 1 | 0T + 1T + 1T + 0T | 0P + 1P + 0P + 0P, 0P + 0P + 1P + 0P |
| Case 2 | 0T + 0T + 2T + 0T | 0P + 0P + 2P + 0P, 0P + 0P + 1P + 0P |
| Case 3 | 0T + 2T + 0T + 0T | 0P + 2P + 0P + 0P, 0P + 1P + 0P + 0P |
| Case 4 | 0T + 0T + 0T + 2T | 0P + 0P + 0P + 2P, 0P + 0P + 0P + 1P |
| Case 5 | 0T + 1T + 0T + 1T | 0P + 1P + 0P + 0P, 0P + 0P + 0P + 1P |
| Case 6 | 0T + 0T + 1T + 1T | 0P + 0P + 0P + 1P, 0P + 0P + 1P + 0P |
| Case 7 | 1T + 0T + 1T + 0T | 1P + 0P + 0P + 0P, 0P + 0P + 1P + 0P |
| Case 8 | 0T + 0T + 2T + 0T | 0P + 0P + 2P + 0P, 0P + 0P + 1P + 0P |
| Case 9 | 2T + 0T + 0T + 0T | 2P + 0P + 0P + 0P, 1P + 0P + 0P + 0P |
| Case 10 | 0T + 0T + 0T + 2T | 0P + 0P + 0P + 2P, 0P + 0P + 0P + 1P |
| Case 11 | 1T + 0T + 0T + 1T | 1P + 0P + 0P + 0P, 0P + 0P + 0P + 1P |
| Case 12 | 0T + 0T + 1T + 1T | 0P + 0P + 1P + 0P, 0P + 0P + 0P + 1P |
| Case 13 | 1T + 1T + 0T + 0T | 1P + 0P + 0P + 0P, 0P + 1P + 0P + 0P |
| Case 16 | 0T + 2T + 0T + 0T | 0P + 2P + 0P + 0P, 0P + 1P + 0P + 0P |
| Case 16 | 2T + 0T + 0T + 0T | 2P + 0P + 0P + 0P, 1P + 0P + 0P + 0P |
| Case 16 | 0T + 0T + 0T + 2T | 0P + 0P + 0P + 2P, 0P + 0P + 0P + 1P |
| Case 17 | 1T + 0T + 0T + 1T | 1P + 0P + 0P + 0P, 0P + 0P + 0P + 1P |
| Case 18 | 0T + 1T + 0T + 1T | 0P + 1P + 0P + 0P, 0P + 0P + 0P + 1P |
| Case 19 | 1T + 1T + 0T + 0T | 1P + 0P + 0P + 0P, 0P + 1P + 0P + 0P |
| Case 20 | 0T + 2T + 0T + 0T | 0P + 2P + 0P + 0P, 0P + 1P + 0P + 0P |
| Case 21 | 2T + 0T + 0T + 0T | 2P + 0P + 0P + 0P, 1P + 0P + 0P + 0P |
| Case 22 | 0T + 0T + 2T + 0T | 0P + 0P + 2P + 0P, 0P + 0P + 1P + 0P |
| Case 23 | 1T + 0T + 1T + 0T | 1P + 0P + 0P + 0P, 0P + 0P + 1P + 0P |
| Case 24 | 0T + 1T + 1T + 0T | 0P + 1P + 0P + 0P, 0P + 0P + 1P + 0P |

In Manner 2, a case that data can be transmitted on different bands/carriers simultaneously may be shown in Table 25.

TABLE 25

| | | Quantities of antenna ports for uplink |
|---|---|---|
| | | transmission (band A (carrier 1) + |
| | Quantities of | band B (carrier 2) + band C (carrier 3) + |
| | transmitters | band D (carrier 4)) |
| Case 1 | 0T + 1T + 1T + 0T | 1P + 0P + 0P + 0P, 0P + 1P + 0P + 0P, |
| | | 0P + 1P + 1P + 0P |
| Case 2 | 0T + 0T + 2T + 0T | 0P + 2P + 0P + 0P, 0P + 1P + 0P + 0P |
| Case 3 | 0T + 2T + 0T + 0T | 2P + 0P + 0P + 0P, 1P + 0P + 0P + 0P |
| Case 4 | 0T + 0T + 0T + 2T | 0P + 0P + 2P + 0P, 0P + 0P + 1P + 0P |
| Case 5 | 0T + 1T + 0T + 1T | 1P + 0P + 0P + 0P, 0P + 0P + 1P + 0P, |
| | | 0P + 1P + 0P + 1P |
| Case 6 | 0T + 0T + 1T + 1T | 0P + 0P + 1P + 0P, 0P + 0P + 0P + 1P, |
| | | 0P + 0P + 1P + 1P |
| Case 7 | 1T + 0T + 1T + 0T | 1P + 0P + 0P + 0P, 0P + 0P + 1P + 0P, |
| | | 1P + 0P + 1P + 0P |
| Case 8 | 0T + 0T + 2T + 0T | 0P + 0P + 2P + 0P, 0P + 0P + 1P + 0P |
| Case 9 | 2T + 0T + 0T + 0T | 2P + 0P + 0P + 0P, 1P + 0P + 0P + 0P |
| Case 10 | 0T + 0T + 0T + 2T | 0P + 0P + 0P + 2P, 0P + 0P + 0P + 1P |
| Case 11 | 1T + 0T + 0T + 1T | 1P + 0P + 0P + 0P, 0P + 0P + 0P + 1P, |
| | | 1P + 0P + 0P + 1P |
| Case 12 | 0T + 0T + 1T + 1T | 0P + 0P + 1P + 0P, 0P + 0P + 0P + 1P, |
| | | 0P + 0P + 1P + 1P |
| Case 13 | 1T + 1T + 0T + 0T | 1P + 0P + 0P + 0P, 0P + 1P + 0P + 0P, |
| | | 1P + 1P + 0P + 0P |
| Case 16 | 0T + 2T + 0T + 0T | 0P + 2P + 0P + 0P, 0P + 1P + 0P + 0P |
| Case 16 | 2T + 0T + 0T + 0T | 2P + 0P + 0P + 0P, 1P + 0P + 0P + 0P |
| Case 16 | 0T + 0T + 0T + 2T | 0P + 0P + 0P + 2P, 0P + 0P + 0P + 1P |
| Case 17 | 1T + 0T + 0T + 1T | 1P + 0P + 0P + 0P, 0P + 0P + 0P + 1P, |
| | | 1P + 0P + 0P + 1P |
| Case 18 | 0T + 1T + 0T + 1T | 0P + 1P + 0P + 0P, 0P + 0P + 0P + 1P, |
| | | 0P + 1P + 0P + 1P |
| Case 19 | 1T + 1T + 0T + 0T | 1P + 0P + 0P + 0P, 0P + 1P + 0P + 0P, |
| | | 1P + 1P + 0P + 0P |
| Case 20 | 0T + 2T + 0T + 0T | 0P + 2P + 0P + 0P, 0P + 1P + 0P + 0P |
| Case 21 | 2T + 0T + 0T + 0T | 2P + 0P + 0P + 0P, 1P + 0P + 0P + 0P |
| Case 22 | 0T + 0T + 2T + 0T | 0P + 0P + 2P + 0P, 0P + 0P + 1P + 0P |
| Case 23 | 1T + 0T + 1T + 0T | 1P + 0P + 0P + 0P, 0P + 0P + 1P + 0P, |
| | | 1P + 0P + 1P + 0P |
| Case 24 | 0T + 1T + 1T + 0T | 0P + 1P + 0P + 0P, 0P + 0P + 1P + 0P, |
| | | 0P + 1P + 1P + 0P |

For Tx switching on four bands, in addition to the foregoing cases of switching on two bands and three bands, a case of switching on four bands is further included. That is, there is one Tx on each of two bands, the two Txs are switched to other two bands respectively, and only 1-port transmission can be supported on the four bands.

### Embodiment 2-1

When Manner 1 is configured, there is one Tx on each of two bands, and the two Txs are switched to other two bands respectively, that is, UE performs 1-port transmission on one band before switching, and performs 1-port transmission on another band after switching, details may be shown in Table 26.

TABLE 26

| | | Quantities of antenna ports for uplink |
|---|---|---|
| | | transmission (band A (carrier 1) + band B |
| | Quantities of | (carrier 2) + band C (carrier 3) + band D |
| | transmitters | (carrier 4)) |
| Case 3 | 0T + 2T + 0T + 0T | 2P + 0P + 0P + 0P, 1P + 0P + 0P + 0P |
| Case 6 | 0T + 0T + 1T + 1T | 0P + 0P + 1P + 0P, 0P + 0P + 0P + 1P |

### Embodiment 2-2

When Manner 2 is configured, there is one Tx on each of two bands, and the two Txs are switched to other two bands respectively, that is, UE performs 1-port transmission on two bands before switching, and performs 2-port transmission on other two bands after switching, details may be shown in Table 27.

TABLE 27

| | | Quantities of antenna ports for uplink |
|---|---|---|
| | | transmission (band A (carrier 1) + band B |
| | Quantities of | (carrier 2) + band C (carrier 3) + band D |
| | transmitters | (carrier 4)) |
| Case 3 | 0T + 2T + 0T + 0T | 2P + 0P + 0P + 0P, 1P + 0P + 0P + 0P, |
| | | 1P + 1P + 0P + 0P |
| Case 6 | 0T + 0T + 1T + 1T | 0P + 0P + 1P + 0P, 0P + 0P + 0P + 1P, |
| | | 0P + 0P + 1P + 1P |

FIG. 3 is a diagram of a structure of a transmission apparatus according to an embodiment of this application. As shown in FIG. 3, the apparatus includes:
a transmission module 301, configured to: in a case that a configured resource for a terminal includes N frequency domain resources, and a preset condition is satisfied by the terminal, perform transmission on a frequency domain resource in the N frequency domain resources, where the transmission is performed based on a transmitter which is any of M transmitters, and N is an integer greater than 2.

The terminal has M transmitters, or the terminal is capable of performing transmission on a maximum of M transmitters simultaneously, where M is a positive integer less than or equal to N.

In some embodiments, performing transmission on the N frequency domain resources includes:
performing Tx switching on a frequency domain resource in the N frequency domain resources, and performing transmission based on a switched-to frequency domain resource.

In some embodiments, the frequency domain resource includes one of the following: a carrier, a BWP, a band, or a resource pool.

In some embodiments, the quantity of antenna ports for transmission of the terminal on a first frequency domain resource is less than or equal to a quantity of transmitters of the terminal on the first frequency domain resource, and the first frequency domain resource is any one of the N frequency domain resources; and/or
M is equal to 2.

In some embodiments, that a preset condition is satisfied includes at least one of the following:
the terminal has a Tx switching capability on at least a part of the N frequency domain resources;
the terminal receives triggering signaling used to trigger Tx switching;
preceding transmission performed by the terminal satisfies a first preset requirement;
transmission that is currently performed by the terminal satisfies the first preset requirement;
transmission that is to be performed by the terminal satisfies a second preset requirement; and
the terminal satisfies a third preset requirement.

In some embodiments, the first preset requirement includes: the terminal performs 1-port transmission in a first frequency domain resource set; and/or
the second preset requirement includes: the terminal performs 1-port transmission in a second frequency domain resource set; and/or
the third preset requirement includes at least one of the following:
the terminal does not support or perform or is not configured or scheduled with 2-port transmission on each frequency domain resource in the first frequency domain resource set and the second frequency domain resource set; and
the terminal supports or performs or is configured or scheduled with only 1-port transmission on each frequency domain resource in the first frequency domain resource set and the second frequency domain resource set.

In some embodiments, the terminal cannot perform transmission on different carriers simultaneously; or
the terminal can perform transmission on different carriers simultaneously.

In some embodiments, the first preset requirement includes: the terminal performs 1-port transmission in a first frequency domain resource set; and/or
the second preset requirement includes: the terminal performs 1-port or 2-port transmission in a second frequency domain resource set; and/or
the third preset requirement includes at least one of the following:
the terminal supports or performs or is configured or scheduled with 2-port transmission on at least one frequency domain resource in the second frequency domain resource set; and
the terminal does not support or perform or is not configured or scheduled with 2-port transmission on a frequency domain resource in the first frequency domain resource set.

In some embodiments, the first preset requirement includes: the terminal performs 1-port or 2-port transmission in a first frequency domain resource set; and/or
the second preset requirement includes: the terminal performs 1-port transmission in a second frequency domain resource set; and/or
the third preset requirement includes at least one of the following:
the terminal supports or performs or is configured or scheduled with 2-port transmission on at least one frequency domain resource in the first frequency domain resource set; and
the terminal does not support or perform or is not configured or scheduled with 2-port transmission on a frequency domain resource in the second frequency domain resource set.

In some embodiments, the first preset requirement includes: the terminal performs 2-port transmission in a first frequency domain resource set; and/or
the second preset requirement includes: the terminal performs 2-port transmission in a second frequency domain resource set; and/or
the third preset requirement includes at least one of the following:
the terminal supports or performs or is configured or scheduled with 2-port transmission on at least one frequency domain resource in the first frequency domain resource set;
the terminal supports or performs or is configured or scheduled with 2-port transmission on at least one frequency domain resource in the second frequency domain resource set; and
the terminal supports or performs or is configured or scheduled with 2-port transmission on a current frequency domain resource.

In some embodiments, the first frequency domain resource set and the second frequency domain resource set separately include different frequency domain resources in the N frequency domain resources.

In some alternative embodiments, the first frequency domain resource set includes a first part of frequency domain resource in the N frequency domain resources, the second frequency domain resource set includes a second part of frequency domain resource in the N frequency domain resources, and the first part of frequency domain resource and the second part of frequency domain resource are partially overlapped.

In some embodiments, the terminal supports at least one of the following antenna transmitting modes:
a first mode, where the first mode indicates that transmitting on only one transmitter is allowed to be performed on one frequency domain resource, or the first mode indicates that transmitting through only one antenna port is allowed to be performed on one frequency domain resource;
a second mode, where the second mode indicates that transmitting on two transmitters is supported on at least one frequency domain resource, and transmitting on only one transmitter is supported on at least one frequency domain resource, or the second mode indicates that transmitting through two antenna ports is supported on at least one frequency domain resource, and transmitting through only one antenna port is supported on at least one frequency domain resource; and
a third mode, where the third mode indicates that transmitting on two transmitters is supported on at least two frequency domain resources, or the third mode indicates that transmitting through two antenna ports is supported on at least two frequency domain resources.

In some embodiments, an antenna transmitting mode supported by the terminal is related to at least one of the following:
a capability of the terminal and a network configuration; and/or
at least one of the first preset requirement, the second preset requirement, and the third preset requirement is associated with the antenna transmitting mode supported by the terminal.

In some embodiments, after switching, in a case that same antenna ports correspond to different transmitter combinations, the terminal determines, based on first indication information transmitted by a network side, target transmitter combinations corresponding to the same antenna ports.

The foregoing transmission apparatus can improve transmission performance of the terminal.

The transmission apparatus in this embodiment of this application may be an electronic device, for example, an electronic device having an operating system, or may be a component in an electronic device, for example, an integrated circuit or a chip. The electronic device may be a terminal, or another device other than a terminal. For example, the terminal may include but is not limited to the types of the terminal enumerated in embodiments of this application. The another device may be a server, a Network Attached Storage (NAS), or the like. This is not limited in embodiments of this application.

The transmission apparatus provided in this embodiment of this application can implement the processes implemented in the method embodiment shown in FIG. 2 and achieve a same technical effect. To avoid repetition, details are not described herein again.

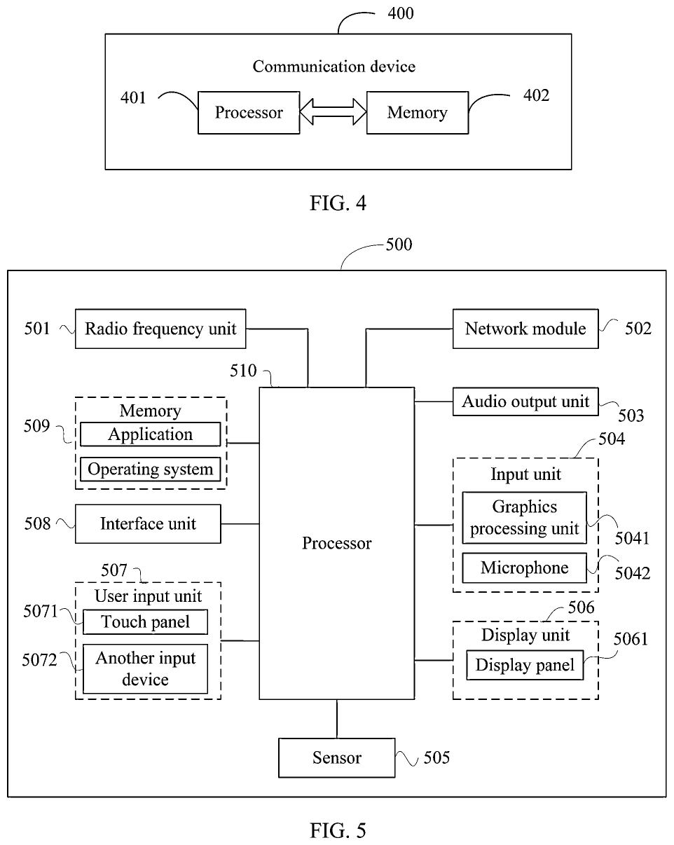

In some embodiments, as shown in FIG. 4, an embodiment of this application further provides a communication device 400, including a processor 401 and a memory 402. The memory 402 stores a program or an instruction executable on the processor 401. For example, when the communication device 400 is a terminal, and the program or the instruction is executed by the processor 401, the steps of the foregoing transmission method embodiment are implemented, and a same technical effect can be achieved.

An embodiment of this application further provides a terminal, including a processor and a communication interface. The communication interface is configured to: in a case that a configured resource for a terminal includes N frequency domain resources, and a preset condition is satisfied by the terminal, perform transmission on a frequency domain resource in the N frequency domain resources, where the transmission is performed based on a transmitter which is any of M transmitters, and N is an integer greater than 2. The terminal has M transmitters, or the terminal is capable of performing transmission on a maximum of M transmitters simultaneously, where M is a positive integer less than or equal to N. The terminal embodiment corresponds to the terminal side method embodiment, the implementation processes and implementations of the method embodiment are applicable to the terminal embodiment, and a same technical effect can be achieved. For example, FIG. 5 is a schematic diagram of a hardware structure of a terminal according to an embodiment of this application.

The terminal 500 includes but is not limited to at least a part of components such as a radio frequency unit 501, a network module 502, an audio output unit 503, an input unit 504, a sensor 505, a display unit 506, a user input unit 507, an interface unit 508, a memory 509, and a processor 510.

A person skilled in the art may understand that the terminal 500 may further include a power supply (such as a battery) that supplies power to each component. The power supply may be logically connected to the processor 510 through a power supply management system, to implement functions such as charging and discharging management, and power consumption management through the power supply management system. The terminal structure shown in FIG. 5 constitutes no limitation on the terminal, and the terminal may include more or fewer components than those shown in the figure, or combine some components, or have different component arrangements. Details are not described herein.

It should be understood that in this embodiment of this application, the input unit 504 may include a Graphics Processing Unit (GPU) 5041 and a microphone 5042. The graphics processing unit 5041 processes image data of a static picture or a video obtained by an image capture apparatus (for example, a camera) in a video capture mode or an image capture mode. The display unit 506 may include a display panel 5061, and the display panel 5061 may be configured in a form of liquid crystal display, organic light-emitting diode, or the like. The user input unit 507 includes at least one of a touch panel 5071 and another input device 5072. The touch panel 5071 is also referred to as a touchscreen. The touch panel 5071 may include two parts: a touch detection apparatus and a touch controller. The another input device 5072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 501 may transmit the downlink data to the processor 510 for processing. In addition, the radio frequency unit 501 may send uplink data to the network side device. Generally, the radio frequency unit 501 includes but is not limited to an antenna, an amplifier, a transceiver, a coupler, a low noise amplifier, a duplexer, and the like.

The memory 509 may be configured to store a software program or an instruction and various data. The memory 509 may mainly include a first storage area for storing a program or an instruction and a second storage area for storing data. The first storage area may store an operating system, an application or an instruction required by at least one function (for example, a sound playing function or an image playing function), and the like. In addition, the memory 509 may include a volatile memory or a non-volatile memory, or the memory 509 may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM), and a Direct Rambus RAM (DRRAM). The memory 509 in this embodiment of this application includes but is not limited to these memories and any memory of another proper type.

The processor 510 may include one or more processing units. In some embodiments, an application processor and a modem processor are integrated into the processor 510. The application processor mainly processes an operation related to an operating system, a user interface, an application, and the like. The modem processor mainly processes a wireless communication signal, for example, a baseband processor. It may be understood that the modem processor may not be integrated into the processor 510.

The radio frequency unit 501 is configured to: in a case that a configured resource for a terminal includes N frequency domain resources, and a preset condition is satisfied by the terminal, perform transmission on a frequency domain resource in the N frequency domain resources, where the transmission is performed based on a transmitter which is any of M transmitters, and N is an integer greater than 2.

The terminal has M transmitters, or the terminal is capable of performing transmission on a maximum of M transmitters simultaneously, where M is a positive integer less than or equal to N.

In some embodiments, performing transmission on a frequency domain resource in the N frequency domain resources includes:
performing Tx switching on a frequency domain resource in the N frequency domain resources, and performing transmission based on a switched-to frequency domain resource.

In some embodiments, the frequency domain resource includes one of the following:
a carrier, a bandwidth part BWP, a band, or a resource pool.

In some embodiments, the quantity of antenna ports for transmission of the terminal on a first frequency domain resource is less than or equal to a quantity of transmitters of the terminal on the first frequency domain resource, and the first frequency domain resource is any one of the N frequency domain resources; and/or
M is equal to 2.

In some embodiments, that a preset condition is satisfied includes at least one of the following:
the terminal has a Tx switching capability on at least a part of the N frequency domain resources;
the terminal receives triggering signaling used to trigger Tx switching;
preceding transmission performed by the terminal satisfies a first preset requirement;
transmission that is currently performed by the terminal satisfies the first preset requirement;
transmission that is to be performed by the terminal satisfies a second preset requirement; and
the terminal satisfies a third preset requirement.

In some embodiments, the first preset requirement includes: the terminal performs 1-port transmission in a first frequency domain resource set; and/or
the second preset requirement includes: the terminal performs 1-port transmission in a second frequency domain resource set; and/or
the third preset requirement includes at least one of the following:
the terminal does not support or perform or is not configured or scheduled with 2-port transmission on each frequency domain resource in the first frequency domain resource set and the second frequency domain resource set; and
the terminal supports or performs or is configured or scheduled with only 1-port transmission on each frequency domain resource in the first frequency domain resource set and the second frequency domain resource set.

In some embodiments, the terminal cannot perform transmission on different carriers simultaneously; or the terminal can perform transmission on different carriers simultaneously.

In some embodiments, the first preset requirement includes: the terminal performs 1-port transmission in a first frequency domain resource set; and/or
the second preset requirement includes: the terminal performs 1-port or 2-port transmission in a second frequency domain resource set; and/or
the third preset requirement includes at least one of the following:
the terminal supports or performs or is configured or scheduled with 2-port transmission on at least one frequency domain resource in the second frequency domain resource set; and
the terminal does not support or perform or is not configured or scheduled with 2-port transmission on a frequency domain resource in the first frequency domain resource set.

In some embodiments, the first preset requirement includes: the terminal performs 1-port or 2-port transmission in a first frequency domain resource set; and/or
the second preset requirement includes: the terminal performs 1-port transmission in a second frequency domain resource set; and/or
the third preset requirement includes at least one of the following:
the terminal supports or performs or is configured or scheduled with 2-port transmission on at least one frequency domain resource in the first frequency domain resource set; and
the terminal does not support or perform or is not configured or scheduled with 2-port transmission on a frequency domain resource in the second frequency domain resource set.

In some embodiments, the first preset requirement includes: the terminal performs 2-port transmission in a first frequency domain resource set; and/or
the second preset requirement includes: the terminal performs 2-port transmission in a second frequency domain resource set; and/or
the third preset requirement includes at least one of the following:
the terminal supports or performs or is configured or scheduled with 2-port transmission on at least one frequency domain resource in the first frequency domain resource set;
the terminal supports or performs or is configured or scheduled with 2-port transmission on at least one frequency domain resource in the second frequency domain resource set; and
the terminal supports or performs or is configured or scheduled with 2-port transmission on a current frequency domain resource.

In some embodiments, the first frequency domain resource set and the second frequency domain resource set separately include different frequency domain resources in the N frequency domain resources.

In some alternative embodiments, the first frequency domain resource set includes a first part of frequency domain resource in the N frequency domain resources, the second frequency domain resource set includes a second part of frequency domain resource in the N frequency domain resources, and the first part of frequency domain resource and the second part of frequency domain resource are partially overlapped.

In some embodiments, the terminal supports at least one of the following antenna transmitting modes:
a first mode, where the first mode indicates that transmitting on only one transmitter is allowed to be performed on one frequency domain resource, or the first mode indicates that transmitting through only one antenna port is allowed to be performed on one frequency domain resource;
a second mode, where the second mode indicates that transmitting on two transmitters is supported on at least one frequency domain resource, and transmitting on only one transmitter is supported on at least one frequency domain resource, or the second mode indicates that transmitting through two antenna ports is supported on at least one frequency domain resource, and transmitting through only one antenna port is supported on at least one frequency domain resource; and
a third mode, where the third mode indicates that transmitting on two transmitters is supported on at least two frequency domain resources, or the third mode indicates that transmitting through two antenna ports is supported on at least two frequency domain resources.

In some embodiments, an antenna transmitting mode supported by the terminal is related to at least one of the following:
a capability of the terminal and a network configuration; and/or
at least one of the first preset requirement, the second preset requirement, and the third preset requirement is associated with the antenna transmitting mode supported by the terminal.

In some embodiments, after switching, in a case that same antenna ports correspond to different transmitter combinations, the terminal determines, based on first indication information transmitted by a network side, target transmitter combinations corresponding to the same antenna ports.

The foregoing transmission apparatus can improve transmission performance of the terminal.

An embodiment of this application further provides a readable storage medium. The readable storage medium stores a program or an instruction. When the program or the instruction is executed by a processor, the processes of the foregoing transmission method embodiment are implemented, and a same technical effect can be achieved. To avoid repetition, details are not described herein again.

The processor is a processor in the terminal in the foregoing embodiments. The readable storage medium includes a computer-readable storage medium, for example, a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction, to implement the processes of the foregoing transmission method embodiment, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program product. The computer program product is stored in a storage medium, and the computer program product is executed by at least one processor, to implement the processes of the foregoing transmission method embodiment, and a same technical effect can be achieved. To avoid repetition, details are not described herein again.

An embodiment of this application further provides a transmission system, including a terminal and a communication device. The terminal may be configured to perform the foregoing transmission steps.

An embodiment of this application further provides a terminal. The terminal is configured to implement the steps of the transmission method provided in embodiments of this application.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element defined by “includes a . . . ” does not preclude the existence of other identical elements in a process, a method, an article, or an apparatus that includes the element. In addition, it should be noted that the scope of the method and the apparatus in implementations of this application is not limited to performing functions in the order shown or discussed, and may further include performing the functions in a basically simultaneous manner or in an opposite order based on the involved functions. For example, the described method may be performed in an order different from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a better implementation. Based on such an understanding, the technical solutions of this application essentially or the part contributing to the prior art may be implemented in a form of computer software product. The computer software product is stored in a storage medium (for example, a ROM/RAM, a magnetic disk, or an optical disc), and includes several instructions for instructing a terminal (which may be a mobile phone, a computer, a server, an air conditioner, a network device, or the like) to perform the method described in embodiments of this application.

Embodiments of this application are described above with reference to the accompanying drawings, but this application is not limited to the foregoing implementations, and the foregoing implementations are merely illustrative and not restrictive. Under the enlightenment of this application, a person of ordinary skill in the art can make many forms without departing from the purpose of this application and the protection scope of the claims, all of which fall within the protection of this application.

1. A transmission method, comprising:
when a configured resource for a terminal comprises N frequency domain resources, and a preset condition is satisfied by the terminal, performing transmission on a frequency domain resource in the N frequency domain resources,
wherein the transmission is performed based on a transmitter which is any of M transmitters, and N is an integer greater than 2,
wherein the terminal has M transmitters, or the terminal performs transmission on a maximum of M transmitters simultaneously,
wherein M is a positive integer less than or equal to N.

2. The transmission method according to claim 1, wherein performing the transmission on the frequency domain resource in the N frequency domain resources comprises:
performing Transmitter (Tx) switching on a frequency domain resource in the N frequency domain resources, and performing transmission based on a switched-to frequency domain resource.

3. The transmission method according to claim 1, wherein the frequency domain resource comprises one of the following:
a carrier, a Bandwidth Part (BWP), a band, or a resource pool.

4. The transmission method according to claim 1, wherein the quantity of antenna ports for transmission of the terminal on a first frequency domain resource is less than or equal to the quantity of transmitters of the terminal on the first frequency domain resource, and the first frequency domain resource is any one of the N frequency domain resources; or
M is equal to 2.

5. The transmission method according to claim 1, wherein that a preset condition is satisfied comprises at least one of the following:
the terminal has a Transmitter (Tx) switching capability on at least a part of the N frequency domain resources;
the terminal receives triggering signaling used to trigger Tx switching;
preceding transmission performed by the terminal satisfies a first preset requirement;
transmission that is currently performed by the terminal satisfies the first preset requirement;
transmission that is to be performed by the terminal satisfies a second preset requirement; or
the terminal satisfies a third preset requirement.

6. The transmission method according to claim 5,
wherein:
the first preset requirement comprises: the terminal performs 1-port transmission in a first frequency domain resource set; or
the second preset requirement comprises: the terminal performs 1-port transmission in a second frequency domain resource set; or
the third preset requirement comprises at least one of the following:
the terminal does not support or perform or is not configured or scheduled with 2-port transmission on each frequency domain resource in the first frequency domain resource set and the second frequency domain resource set; or
the terminal supports or performs or is configured or scheduled with only 1-port transmission on each frequency domain resource in the first frequency domain resource set and the second frequency domain resource set.

7. The transmission method according to claim 5,
wherein:
the first preset requirement comprises: the terminal performs 1-port transmission in a first frequency domain resource set; or
the second preset requirement comprises: the terminal performs 1-port or 2-port transmission in a second frequency domain resource set; or
the third preset requirement comprises at least one of the following:
the terminal supports or performs or is configured or scheduled with 2-port transmission on at least one frequency domain resource in the second frequency domain resource set; or
the terminal does not support or perform or is not configured or scheduled with 2-port transmission on a frequency domain resource in the first frequency domain resource set.

8. The transmission method according to claim 5,
wherein:
the first preset requirement comprises: the terminal performs 1-port or 2-port transmission in a first frequency domain resource set; or
the second preset requirement comprises: the terminal performs 1-port transmission in a second frequency domain resource set; or
the third preset requirement comprises at least one of the following:
the terminal supports or performs or is configured or scheduled with 2-port transmission on at least one frequency domain resource in the first frequency domain resource set; or
the terminal does not support or perform or is not configured or scheduled with 2-port transmission on a frequency domain resource in the second frequency domain resource set.

9. The transmission method according to claim 5,
wherein:
the first preset requirement comprises: the terminal performs 2-port transmission in a first frequency domain resource set; or
the second preset requirement comprises: the terminal performs 2-port transmission in a second frequency domain resource set; or
the third preset requirement comprises at least one of the following:
the terminal supports or performs or is configured or scheduled with 2-port transmission on at least one frequency domain resource in the first frequency domain resource set;
the terminal supports or performs or is configured or scheduled with 2-port transmission on at least one frequency domain resource in the second frequency domain resource set; or
the terminal supports or performs or is configured or scheduled with 2-port transmission on a current frequency domain resource.

10. The transmission method according to claim 6, wherein
the first frequency domain resource set and the second frequency domain resource set separately comprise different frequency domain resources in the N frequency domain resources; or
the first frequency domain resource set comprises a first part of frequency domain resource in the N frequency domain resources, the second frequency domain resource set comprises a second part of frequency domain resource in the N frequency domain resources, and the first part of frequency domain resource and the second part of frequency domain resource are partially overlapped.

11. The transmission method according to claim 1, wherein the terminal supports at least one of the following antenna transmitting modes:
a first mode, wherein the first mode indicates that transmitting on only one transmitter is allowed to be performed on one frequency domain resource, or the first mode indicates that transmitting through only one antenna port is allowed to be performed on one frequency domain resource;
a second mode, wherein the second mode indicates that transmitting on two transmitters is supported on at least one frequency domain resource, and transmitting on only one transmitter is supported on at least one frequency domain resource, or the second mode indicates that transmitting through two antenna ports is supported on at least one frequency domain resource, and transmitting through only one antenna port is supported on at least one frequency domain resource; or
a third mode, wherein the third mode indicates that transmitting on two transmitters is supported on at least two frequency domain resources, or the third mode indicates that transmitting through two antenna ports is supported on at least two frequency domain resources.

12. The transmission method according to claim 5, wherein an antenna transmitting mode supported by the terminal is related to at least one of the following:
a capability of the terminal and a network configuration; or
at least one of the first preset requirement, the second preset requirement, or the third preset requirement is associated with the antenna transmitting mode supported by the terminal.

13. The transmission method according to claim 1, wherein after switching, when same antenna ports correspond to different transmitter combinations, the terminal determines, based on first indication information transmitted by a network side, target transmitter combinations corresponding to the same antenna ports.

14. A terminal, comprising: a processor; and a memory having a computer program or an instruction stored thereon, and wherein the computer program or the instruction, when executed by a processor, causes the processor to perform operations, comprising:
when a configured resource for the terminal comprises N frequency domain resources, and a preset condition is satisfied by the terminal, performing transmission on a frequency domain resource in the N frequency domain resources,
wherein the transmission is performed based on a transmitter which is any of M transmitters, and N is an integer greater than 2,
wherein the terminal has M transmitters, or the terminal performs transmission on a maximum of M transmitters simultaneously,
wherein M is a positive integer less than or equal to N.

15. The terminal according to claim 14, wherein performing the transmission on the frequency domain resource in the N frequency domain resources comprises:
performing Transmitter (Tx) switching on a frequency domain resource in the N frequency domain resources, and performing transmission based on a switched-to frequency domain resource.

16. The terminal according to claim 14, wherein the frequency domain resource comprises one of the following:
a carrier, a Bandwidth Part (BWP), a band, or a resource pool.

17. The terminal according to claim 14, wherein the quantity of antenna ports for transmission of the terminal on a first frequency domain resource is less than or equal to the quantity of transmitters of the terminal on the first frequency domain resource, and the first frequency domain resource is any one of the N frequency domain resources; or
M is equal to 2.

18. The terminal according to claim 14, wherein that a preset condition is satisfied comprises at least one of the following:
the terminal has a Transmitter (Tx) switching capability on at least a part of the N frequency domain resources;
the terminal receives triggering signaling used to trigger Tx switching;
preceding transmission performed by the terminal satisfies a first preset requirement;
transmission that is currently performed by the terminal satisfies the first preset requirement;
transmission that is to be performed by the terminal satisfies a second preset requirement; or
the terminal satisfies a third preset requirement.

19. The terminal according to claim 18,
wherein:
the first preset requirement comprises: the terminal performs 1-port transmission in a first frequency domain resource set; or
the second preset requirement comprises: the terminal performs 1-port transmission in a second frequency domain resource set; or
the third preset requirement comprises at least one of the following:
the terminal does not support or perform or is not configured or scheduled with 2-port transmission on each frequency domain resource in the first frequency domain resource set and the second frequency domain resource set; or
the terminal supports or performs or is configured or scheduled with only 1-port transmission on each frequency domain resource in the first frequency domain resource set and the second frequency domain resource set.

20. A non-transitory computer-readable storage medium storing a computer program or an instruction that, when executed by a processor, causes the processor to perform operations, comprising:
when a configured resource for a terminal comprises N frequency domain resources, and a preset condition is satisfied by the terminal, performing transmission on a frequency domain resource in the N frequency domain resources,
wherein the transmission is performed based on a transmitter which is any of M transmitters, and N is an integer greater than 2,
wherein the terminal has M transmitters, or the terminal performs transmission on a maximum of M transmitters simultaneously,
wherein M is a positive integer less than or equal to N.
